(19) United States
(12) Patent Application Publication
(10) Pub. No.: US 2025/0130120 A1
(43) Pub. Date: Apr. 24, 2025

(54) Method for Monitoring Temperature, Electrical Energy Storage System and at Least Partially Electric Vehicle

(71) Applicant: Mercedes-Benz Group AG, Stuttgart (DE)

(72) Inventors: Jan Philipp SCHMIDT, Creussen (DE); Ronnie WIESER, Goeppingen (DE)

(21) Appl. No.: 18/682,677

(22) PCT Filed: Aug. 2, 2022
(86) PCT No.: PCT/EP2022/071752

§ 371 Date: Feb. 9, 2024

(30) Foreign Application Priority Data
Aug. 12, 2021 (DE) 10 2021 004 156.9

(51) Int. Cl. G01K 7/42; G01K 1/022; H02J 7/00

(52) U.S. Cl. CPC G01K 7/427; G01K 1/022; H02J 7/00309; H02J 7/0071; G01K 2217/00; H02J 2310/48

(57) ABSTRACT

A method for monitoring a temperature of an electrical/electronic component connected via an electrical lead system includes using a temperature sensor in heat-conductive contact with the electrical lead system to record a current temperature and determining a temperature of the electrical/electronic component by a model from the current temperature of the temperature sensor when a current is switched off.

### BACKGROUND AND SUMMARY OF THE INVENTION

The invention relates to a method for monitoring temperature. The invention additionally relates to an electrical energy storage system having at least one battery and to an electrical/electronic component which is monitored with regard to its temperature and to an at least partially electric vehicle having such an energy storage system.

A method for predicting the usability of a relay or a connector in an electrical energy storage system is known from WO 2012/045532 A1. The method can in particular be implemented in a monitoring unit, which is used together with a battery, in particular the traction battery of a motor vehicle. For this purpose, it is in particular crucial to monitor the relay or connector as an electrical/electronic component with regard to its temperature. In the case of high driving, recuperation or charging power, the components of the electrics/electronics in the energy storage system heat up, and this relates in particular to the relay and connector. This plays a particularly important role when charging, in particular when fast charging the battery. In order to avoid the electrics/electronics being overloaded, a protective function can be implemented, which estimates the temperature increase of the connector on the basis of a model, as described in the specified WO publication, and in an emergency correspondingly reduces the power or the current.

It is the case, however, that the worst-case scenario, and thus the maximum power loss in the components has to be taken into account in order to guarantee a safe operation. In many cases, the current or the power is thus reduced earlier and/or more significantly than necessary. This is a serious disadvantage when charging with regard to the charging time, in recuperation with regard to the quantity of energy regained and in electric travel with regard to the performance of the vehicle. Such an unnecessarily significant reduction of the current can however also be understood as a disadvantage for electrical energy systems which are not connected to a vehicle.

Reference can further be made to US 2015/0130469 A1 as further prior art.

The object of the present invention is to specify an improved method and an energy storage system for use with this improved method which in particular avoid the specified disadvantage.

The method according to the invention uses a model which is in principle comparable with the prior art, but the model estimates the temperature of the electric/electronic component to be monitored via a temperature sensor in heat-conductive contact with the electrical lead system. Such an electrical lead system also conducts the heat, which for example arises in the region of the contacts of a connector, over a particular distance up to the temperature sensor, such that for example a temperature sensor can be used at a central point to monitor several connectors. As soon as the current is switched off, no more heat will be created. However, there is still a further increase in temperature in the region of the temperature sensor arranged at a distance from the primary heat source, e.g., a connector, caused by the temporal delay due to the heat conduction to the temperature sensor.

The modelling in the method according to the invention is then exceptionally easy, and serves exclusively to reasonably reliably determine the temperature of the electric/electronic component from the temperature in the temperature sensor. This is easy, efficient, and can even save complexity with regard to the number of temperature sensors and in particular with regard to the required cabling and/or mounting in comparison with the installation of temperature sensors in a plurality of components to be monitored.

According to an exceptionally favorable development of the method according to the invention, it is provided that the model represents a time offset of the temperature in the component in relation to the temperature in the temperature sensor. Even in systems with very little computing power, such an exceptionally simple and efficient model is sufficient to correspondingly represent the time delay for the conduction of the temperature via the leads of the electrical lead system from the component to be monitored to the temperature sensor. The model itself can then, for example, be based on time constants depending on absolute temperature, which time constants can be obtained by simulation calculations and/or measurements in actual and comparable systems.

This exceptionally simple model offers advantages with regard to the required computing capacity and with regard to a potential switch-off threshold, because the switch-off threshold can now be very reliably determined by using the temperature sensor, such that no notable safety behaviors are necessary and the available current, and thus ultimately the available power, can be ideally used in the system with the electric/electronic component. Only when the temperature increase passes a pre-determined threshold value is a corresponding reaction necessary and the current reduced. Unlike in pure modelling according to the prior art, a significantly better value can be generated by using the temperature sensor than in the otherwise necessary worst-case consideration.

According to an advantageous development, it can be provided that, for example, during the (fast) charging, the current and thus the power is switched off from time to time in order to carry out the measurement and to monitor the state of the electrical/electronic component. 10 to 20 seconds are typically sufficient for this purpose, such that the charging process is not substantially lengthened. It is thus still possible to monitor the state of the electric/electronic component from time to time, e.g., hourly, even during the operation.

An exceptionally favorable development of the method according to the invention provides that at least one switch, in particular a relay or a connector, is monitored as an electrical/electronic component. The method is in particular ideally suited to monitor a relay or a connector comparable to the prior art specified in the introduction. It is possible to reliably protect against an unnecessarily significant increase in the temperature of the switch via a suitable threshold value of the temperature while taking into account the very simple model, which has already been calculated in advance with the temperature or is currently implemented depending on the measured temperature, without a reduction of the current being implemented unnecessarily early.

According to a further very favorable embodiment of the method according to the invention, the switch can be designed as part of an electric energy storage system having at least one battery. According to a very advantageous development, the electric energy storage system can be used in a vehicle to provide electric drive energy. The method according to the invention can in particular be ideally used in such systems to avoid the disadvantages described in the introduction and always to guarantee the maximum performance depending on the temperature of the electrical/electronic components, in particular the connector, whether during charging or recuperation on the one hand or in the driving operation of the vehicle on the other hand.

Instead of a dedicated temperature sensor for the method according to the invention, it can be provided according to an exceptionally favorable development that a temperature sensor installed in a further electrical/electronic component is used as a temperature sensor. Electrical/electronic components often already have temperature sensors installed. This does not typically apply to the connector and/or relay, which should be correspondingly monitored in an electrical energy storage system, but typically applies to current sensors, for example. According to a particularly favorable development of the method, it can thus be provided that an ammeter is used as the further component with the temperature sensor. If such an ammeter has a temperature sensor, it offers the advantage that it is directly connected to the electrical/electronic component to be monitored, for example the connector, via the electrical lead system. The current sensor of the ammeter, which is present regardless, and thus causes no additional complexity with regard to hardware, installation and cabling, can thus be easily and efficiently called upon to be used as a temperature sensor in the method according to the invention in one of the embodiments described.

As already specified, the method may preferably be used in an electrical energy storage system. An electrical energy storage system according to the invention comprises at least one battery and electrical components connected via an electrical lead system, wherein at least one of the electrical/electronic components is monitored with regard to its temperature, for which purpose a temperature sensor in heat-conductive contact with the electrical lead system is provided. This then allows the corresponding use to monitor temperature, such that when a limit temperature is reached in the region of the temperature sensor, which can preferably be projected in the manner of the model described in the introduction over the time offset onto the component to be monitored, the behavior of this component can be influenced accordingly, for example by reducing the current.

According to an advantageous development of the electrical energy storage system, the electrical/electronic component to be monitored with regard to its temperature can be a relay or a connector, as already indicated in principle above. According to an exceptionally favorable development, the temperature sensor can be arranged in a further electrical/electronic component, in particular an ammeter of the system, and thus be in electrical and thus also at least indirect heat-conducting connection with the electrical/electronic component to be monitored with regard to its temperature via the electrical lead system.

The electrical energy storage system can preferably be used to provide electrical drive power in a vehicle. The vehicle can be used as an electric battery vehicle (BEV) or as a hybrid vehicle having a battery and an internal combustion engine, a fuel cell or the like as a primary drive unit or as a range extender.

Further advantageous embodiments of the method according to the invention and of an electrical energy storage system according to the invention result from the exemplary embodiment, which is depicted in more detail in the following with reference to the Figures.

### BRIEF DESCRIPTION OF THE DRAWINGS

FIG. 1 shows a schematic switch diagram of an energy storage system in a possible embodiment for carrying out the method according to the invention;

FIG. 2 shows a schematic overview of the possible sequence of the method in a flow diagram; and

FIG. 3 shows a depiction of the temperature curve over time for different heat inputs in a component on the one hand and the measurement result connected to the latter in a temperature sensor on the other hand.

### DETAILED DESCRIPTION OF THE DRAWINGS

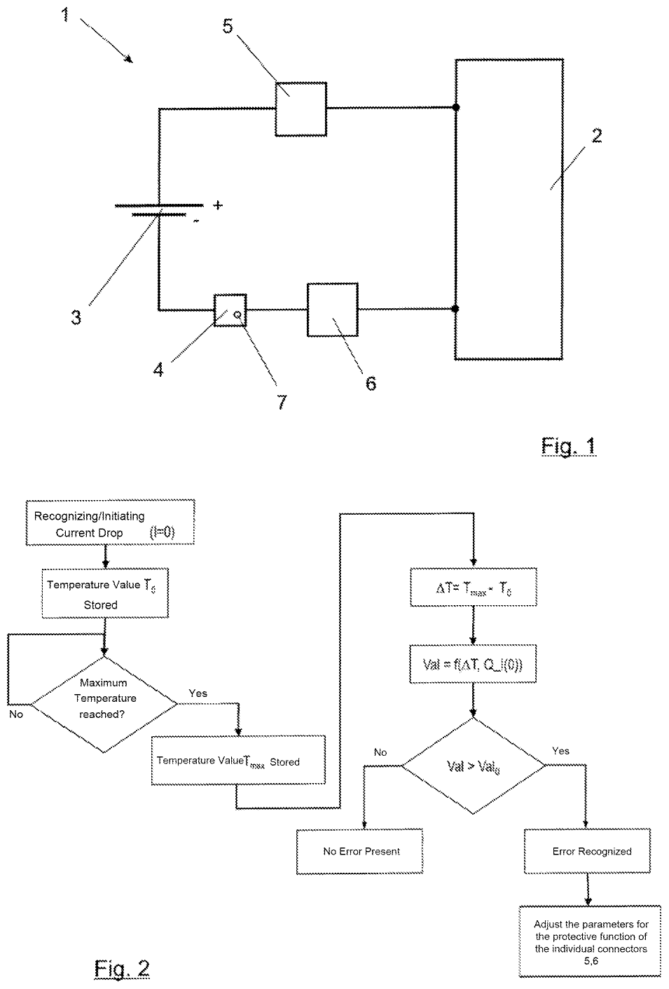

In the depiction of FIG. 1, an electrical energy storage system 1 can be seen, as it can for example be used in a vehicle (not depicted here). Only an electric vehicle system 2 connected to the energy storage system 1 is depicted in the depiction of FIG. 1, which can have consumers and energy sources for the electrical energy storage system 1, and which can for example be used to charge or fast charge the electrical energy storage system 1 via an external charging connection (not depicted here). A battery 3, a current sensor 4 and two connectors 5, 6 are depicted within the electrical energy storage system 1 in the positive and the negative conductor rail. Further fuse elements, e.g., melt fuses, pyro-fuses or the like, which can be arranged on the positive side, in particular between the battery and the connector 5, and on the negative side, in particular between the connector 6 and the electrical vehicle system 2, are not depicted.

In operation, it is the case that an increased temperature arises in the region of the current sensor 4 and in the region of further electrical/electronic components, which are here in particular formed by the connectors 5, 6. Permissible temperatures in the region of the current sensor are for example up to 80° C., in the region of the connectors 5, 6 up to 140° C. In particular in the region of the connectors 5, 6, the temperature can increase very significantly when dealing with high power, in particular when charging and here in particular when fast charging, which makes it necessary to reduce the power, here the charging power, in order not to thermally overload the system.

To monitor the temperature of the connectors 5, 6, it would be conceivable in principle to arrange one temperature sensor in the region of each of the connectors 5, 6, and to connect the latter via corresponding data leads in order to specifically request the temperature here. This is exceptionally complex in practice, both with regard to hardware and in particular with regard to the required mounting of sensors and leads. It is now the case, however, that many ammeters 4 have integrated temperature sensors. The ammeter 4 depicted here is such an ammeter and has an integrated temperature sensor 7.

The fundamental idea in the method described in the following is that a relatively good heat conduction from the connectors 5, 6 to the temperature sensors 7 is present in the ammeter 4 via the lead system arranged in the electrical energy storage system 1 in FIG. 1, and thus in particular the connection of the battery 3 with the connectors 5, 6 via solid conductor rails made of copper or aluminium.

If the power of the electrical energy storage system 1 is switched off, such that no more current flows, then an increase in temperature can still be determined in the region of the temperature sensor 7 because a higher temperature is typically present in the region of the connectors 5, 6 than in the region of the ammeter 4 itself, which increase in temperature cannot in principle result from flowing currents, because, as already specified, this current is switched off. The increase in temperature is thus based on a heat conduction between the connectors 5, 6, which have the higher temperature than the current sensor 4, and the current sensor 4. Thus, if temperature increases in the region of the temperature sensor 7 within the current sensor 4 at a temporal offset from the current being switched off, the temperature in the region of the connectors 5, 6 can be exceptionally easily and efficiently derived from this value, in order thus to reliably receive a report of the temperature behavior in the region of the connectors 5, 6, and thus to determine a potential aging or a wear of the connectors 5, 6 or their contacts involved in switching the power.

A corresponding method for monitoring the temperature T of the connectors 5, 6 as electrical/electronic components can thus be carried out in particular in operating pauses, charging pauses or at the end of an operating or charging process. In particular during charging, and in particular during fast charging, correspondingly high powers and heat loads of the electrical/electronic components arise. In the event of charging, or preferably fast charging, the method can thus be implemented by briefly suspending charging and switching off the power. A waiting period for example of 20 or 30 seconds can then follow, and the offset temperature increase can be correspondingly evaluated in the temperature sensor 7, in order to determine a load or aging of the connectors 5, 6 and then in some instances to adjust the operating parameters, in particular the maximum permissible current in such an operating situation.

The sequence of such a monitoring method is described in the following with reference to the depiction of a flow diagram in FIG. 2. In principle, the method always starts with recognising or initiating a current drop. This is symbolized in the first box by the description I=0. A starting temperature value is then correspondingly stored in the temperature sensor 7, which is labelled T₀ here. The temperature T is subsequently repeatedly checked to determine whether the maximum temperature has been reached. This can in particular be determined if a temperature value is smaller than the previous value, which can subsequently be determined as the maximum value. If such a maximum value of the temperature T has been reached, then this maximum value Tₘₐₓ is correspondingly stored, and a temperature difference ΔT can be calculated from both stored temperature values. In the following box, a comparison value VAL is calculated as a function of the temperature difference ΔT and an energy input Q, which can be based on the long-term cooling capacity and recorded current values before switching off the current. It is then queried whether this comparison value VAL is greater than a pre-determined threshold value VAL₀. If this is not the case, then no error is present; if this is the case, then an error has been recognized and the parameters for a protective function of the individual connectors 5, 6 must be adjusted, in particular the maximum permissible current values or powers must be reduced.

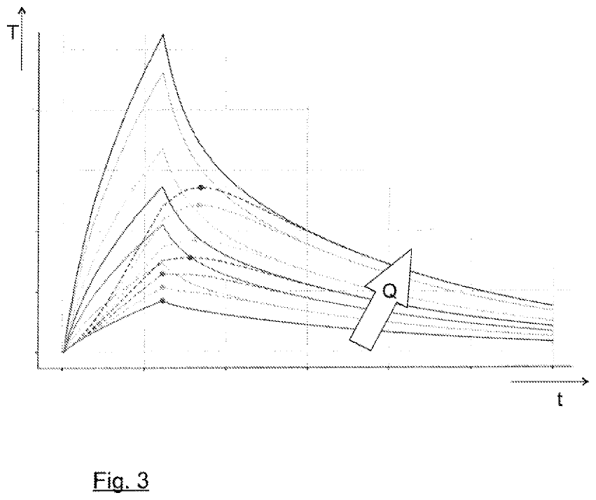

As already specified above, the basis of the entire consideration is that the temperature T in the region of the temperature sensor 7 corresponds to the actual temperature development in the region of the connectors 5, 6 in principle, but lags behind the actual temperature development accordingly. In the depiction of FIG. 3, this is correspondingly depicted using a diagram of the temperature T over time t. Different heat inputs are depicted with solid lines from bottom to top, the heat inputs increasing according to the arrow Q. The solid lines show the respective maximum values of the temperature T present in the region of one of the connectors 5, 6, while the dashed lines show the corresponding temperature T in the temperature sensor 7. In the low heat quantities depicted at the bottom, these two curves almost coincide, and the time, indicated here with a dot, of the maximum temperature Tmax in the temperature sensor 7 almost coincides with the maximum temperature in one of the connectors 5, 6. There is barely any temporal lag here. Even in the second curve from the bottom, however, the temperatures differ significantly, even if the temporal lag is still not present here to a noteworthy extent. Only from the fourth curve from the bottom, and thus a fourth assumed heat input Q, does a significant delay of the temporal lag arise, which can be used in turn to derive the actual maximum temperature in the region of the respective connector 5, 6 from the temporal delay and the temperature that arose at the temperature sensor 7, and thus to monitor the temperature in the region of the connectors 5, 6 as electrical/electronic components exceptionally easily and efficiently with the temperature sensor 7 present regardless in the current sensor 4 without needing to perform complicated modelling, and in particular without needing to install dedicated temperature sensors in the region of the connectors 5, 6.

1.-10. (canceled)

11. A method for monitoring a temperature of an electrical/electronic component connected via an electrical lead system, comprising the steps of:
using a temperature sensor in heat-conductive contact with the electrical lead system to record a current temperature; and
determining a temperature of the electrical/electronic component by a model from the current temperature of the temperature sensor when a current is switched off.

12. The method according to claim 11, wherein the model represents a time offset of the temperature of the electrical/electronic component in relation to the current temperature.

13. The method according to claim 11, wherein the current is switched off from time to time for a measuring time period to record the current temperature.

14. The method according to claim 11, wherein the electrical/electronic component is a switch.

15. The method according to claim 14, wherein the switch is part of an electrical energy storage system that has a battery.

16. The method according to claim 11, wherein the temperature sensor is installed in an ammeter.

17. An electrical energy storage system, comprising:
a battery;
a first electrical/electronic component connected via an electrical lead system, wherein the first electrical/electronic component is monitored with regard to a temperature of the first electrical/electronic component; and
a temperature sensor disposed in a second electrical/electronic component within the electrical lead system, wherein the temperature sensor is used in monitoring the temperature of the first electrical/electronic component.

18. The electrical energy storage system according to claim 17, wherein the first electrical/electronic component is a relay or connector.

19. The electrical energy storage system according to claim 17, wherein the second electrical/electronic component is an ammeter.

20. A vehicle, comprising:
an at least partially electric drive which has an electrical energy storage system according to claim 17.
